(19) United States
(12) Patent Application Publication
(10) Pub. No.: US 2007/0097226 A1
(43) Pub. Date: May 3, 2007

(54) Image data processing semiconductor integrated circuit

(76) Inventors: Koji Shida, Tokyo (JP); Jun Suzuki, Tokyo (JP); Yoichi Kato, Tokyo (JP); Hidehito Yamada, Yokohama (JP); Akihito Nishizawa, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/582,994

(22) Filed: Oct. 19, 2006

(30) Foreign Application Priority Data
Oct. 31, 2005 (JP) 2005-315693

(51) Int. Cl. H04N 5/228

(52) U.S. Cl. 348/222.1

(57) ABSTRACT

The invention is intended to reduce the number of parts constituting an image capturing system using a solid-state image sensor and reduce the size and cost of a mobile electronic appliance having camera functionality. An analog front end circuit for an image capturing system, which samples pixel readout signals input from a solid-state image sensor, amplifies the sampled signals up to a predetermined level, and converts the amplified signals into digital signals, is formed, together with a DSP for digital image processing and a CPU responsible for arithmetic processing and control for camera functionality such as auto focusing and register setting, in a semiconductor integrated circuit on a single semiconductor chip.

### CROSS-REFERENCE TO RELATED APPLICATION

The present application claims priority from Japanese application No. 2005-315693 filed on Oct. 31, 2005, the content of which is hereby incorporated by reference into this application.

### BACKGROUND OF THE INVENTION

The present invention relates to an image processing technique for processing captured image signals output by a solid-state image sensor. In particular, the invention relates to a technique that is effectively used for an image data processing semiconductor integrated circuit which processes analog captured image signals output by a solid-state image sensor.

As image sensors in video cameras and still cameras, a CCD type solid-state image sensor and a CMOS type solid-state image sensor are available. For the former CCD type solid-state image sensor, after parallel transfer of stored charges per pixel obtained by photoelectric conversion of incident light to a transfer CCD, the charges are serially transferred within the transfer CCD and output. To increase the charge transfer efficiency within the CCD, it is required to produce a high potential difference. This results in large power consumption.

On the other hand, for the CMOS type solid-state image sensor, the stored charges per pixel obtained by photoelectric conversion of incident light are converted to per-pixel voltages which are then amplified. The thus amplified voltages of the pixels are read by sequentially selecting each pixel's voltage by a matrix selection circuit. In this method, the device can operate with a single power supply of, for example, about +3.3 V, and power consumption can be reduced by a factor of several times as compared to the CCD type. Moreover, because this device can be manufactured by utilizing a CMOS process, its integration together with its peripheral circuits such as an A/D converter and an amplifier circuit is easy to implement. Therefore, an invention relating to a CMOS type solid-state image sensor integrated with its peripheral circuits such as an A/D converter and an amplifier circuit has been proposed (e.g., Patent Document 1).

[Patent Document 1] Japanese Unexamined Patent Publication No. 2003-224778

### SUMMARY OF THE INVENTION

The chip size of the CCD type solid-state image sensor (hereinafter referred to as a CCD sensor) is likely to be larger than that of the CMOS type solid-state image sensor (hereinafter referred to as a CMOS sensor), because the CCD sensor manufacturing process is more complicated than the CMOS process and a CCD for transferring charges is needed along with a CCD for photoelectric conversion. Thus, an image capturing system using a CCD sensor is typically configured, using a separate semiconductor circuit structure called an analog front end (AFE) in which peripheral circuits such as an A/D converter and an amplifier circuit are formed, besides the CCD sensor and an image processing semiconductor integrated circuit (DSP), as is shown in FIG. 7.

Consequently, the number of parts such as semiconductor chips constituting the image capturing system (a so-called electronic camera) using the CCD sensor becomes greater than the corresponding system using the CMOS sensor. This would be a cause making it impossible to downsize appliances such as mobile phones incorporating an electronic cameral using the CCD sensor. Furthermore, the AFE and the image processing DSP are connected by a bus with a width of 10-14 bits. This poses further problems in which power consumption is further increased by driving the bus and the bus operation itself becomes a source of noise to the analog circuits.

The present invention has been made to address the above problems and its objects are to reduce the number of parts constituting an image capturing system using a solid-state image sensor and to reduce the size and cost of mobile electronic appliances including a camera function.

Another object of the invention is to reduce the number of wiring connections between semiconductor chips constituting an image capturing system using a solid-state image sensor, thus reducing power consumption and suppressing image quality degradation due to noise.

A further object of the invention is to enable quicker booting of an image capturing system using a solid-state image sensor.

A still further object of the invention is to provide image data processing semiconductor integrated circuit that is versatile for application in both types of image capturing systems using either the CCD sensor or the CMOS sensor as the image sensor.

The above and other objects and novel features of the present invention will become apparent from the description of the specification and the appended drawings.

Typical aspects of the invention disclosed herein will be summarized below.

An aspect of the invention provides an image data processing semiconductor integrated circuit adapted such that an AFE (analog front end) circuit for an image capturing system, which samples pixel readout signals input from a solid-state image sensor, amplifies the sampled signals up to a predetermined level, and converts the amplified signals into digital signals, is formed, together with a DSP (digital signal processor) for digital image processing and a CPU (central processing unit, or microcomputer) responsible for arithmetic processing and control for the DSP and camera functionality such as auto focusing and register setting, in the semiconductor integrated circuit on a single semiconductor chip.

By the arrangement in which the AFE, which was conventionally formed separately from a CCD sensor and an image processing semiconductor integrated circuit (DSP), is formed together with the DSP and the CPU in a single chip semiconductor integrated circuit, it becomes possible to reduce the number of parts constituting the image capturing system and reduce the size and cost of a mobile electronic appliance having camera functionality.

By the arrangement in which the AFE circuit is formed together with the DSP and the CPU in a single chip semiconductor integrated circuit, the bus signal line through which the pixel readout signals are sent from the AFE circuit to the DSP can be formed on the chip instead of the printed wiring board. Generally, space for signal wiring within a chip can be smaller than space for signal wiring on a printed wiring board. Therefore, power consumption required to drive the bus can be reduced. Also, it becomes possible to suppress noise generation and suppress image quality degradation, as the bus can be driven with less power.

Preferably, a register provided to set the gain of a variable gain amplifier circuit within the AFE circuit and the like may be arranged such that a value sent in a parallel manner from the CPU via an internal bus is set in the register.

In the case where the AFE circuit is formed in a separate semiconductor chip different from the DSP chip, serial transfer of register setting data is required to allow the CPU to set the register within the AFE circuit without increasing the number of wiring connections and the number of terminals between the chips. However, such serial transfer requires serial/parallel conversion in the route of the transmission, which results in delay in booting of the system. By the arrangement that allows the CPU to set the register by sending a setting to the register in a parallel manner, quicker booting of the system can be achieved.

Further, preferably, the image data processing semiconductor integrated circuit may include a signal path for guiding digital pixel signals input from the solid-state image sensor to the DSP, bypassing the AFE circuit, and a selector circuit (selecting means) for selecting either signals from this signal path or digital pixel signals input via the AFE circuit. Thereby, it is possible to provide a versatile image data processing semiconductor integrated circuit that is able to process signals from both types of devices, the CCD sensor without the AFE circuit and the CMOS sensor including the AFE circuit. Furthermore, when developing an image data processing semiconductor integrated circuit adapted for the CMOS sensor, based on an image data processing semiconductor integrated circuit for use connected to the CCD sensor, if the integrated circuit is configured so that processing is switchable between signals from the CMOS and signals from the CCD by using such selector circuit, it can be developed easily and the development cost and term can be reduced.

Effect that will be achieved by typical aspects of the invention disclosed herein will be briefly described below.

According to the present invention, it is possible to reduce the number of parts constituting an image capturing system using a solid-state image sensor and reduce the size and cost of a mobile electronic appliance having camera functionality.

### BRIEF DESCRIPTION OF THE DRAWINGS

FIG. 1 is a block diagram representing a first embodiment of an image data processing semiconductor integrated circuit to which the present invention is applied and an example of an image capturing system configuration using this embodiment.

FIG. 2 is a block diagram representing a second embodiment of an image data processing semiconductor integrated circuit to which the present invention is applied and an example of an image capturing system configuration using this embodiment.

FIG. 3 is a block diagram showing an example of circuit configuration designed to allow the CPU to configure the gain setting register for the various gain amplifier circuit in the case where the AFE circuit is formed in a separate semiconductor chip different from the DSP chip.

FIG. 4 is a block diagram showing an example of an essential configuration of a third embodiment of an image processing semiconductor integrated circuit according to the present invention.

FIG. 5 is a schematic diagram showing an example of a CMOS sensor structure capable of outputting a plurality of channels of image signal readout.

FIG. 6 is a schematic diagram showing an example of a CCD sensor structure capable of outputting a plurality of channels of image signal readout.

FIG. 7 is a block diagram showing an example of a conventional image data processing semiconductor integrated circuit and an example of an image capturing system using this IC.

### DETAILED DESCRIPTION OF THE PREFERRED EMBODIMENTS

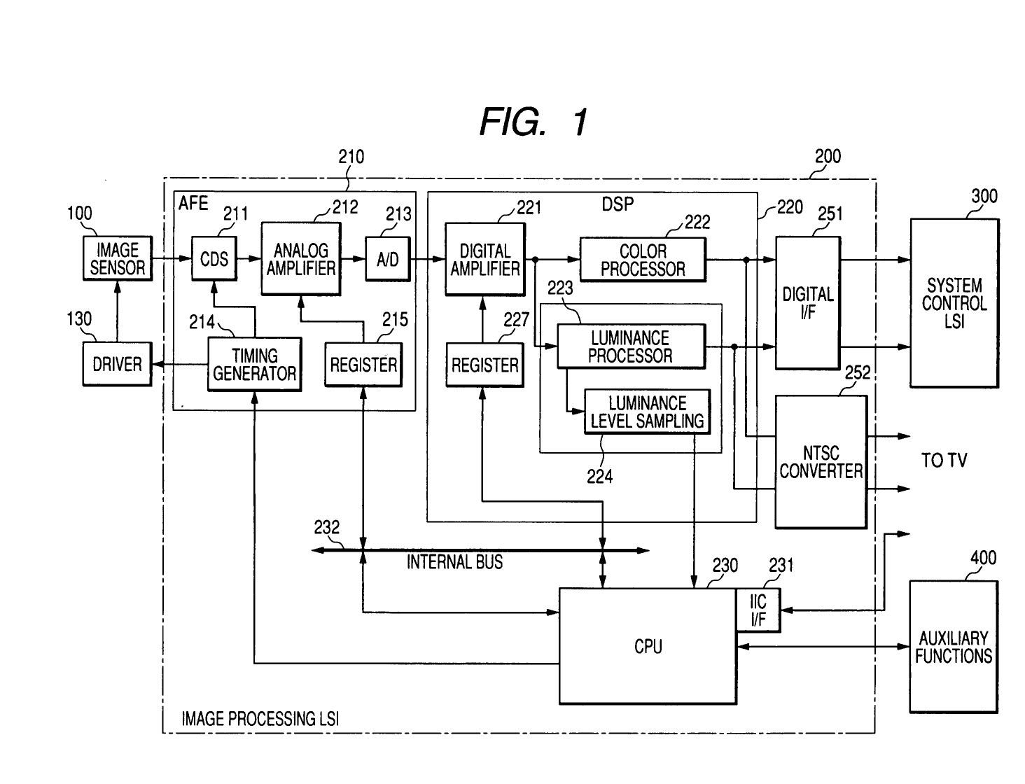

FIG. 1 shows a block diagram representing a first embodiment of an image data processing semiconductor integrated circuit (hereinafter referred to as an image processing LSI) to which the present invention is applied and an example of an image capturing system configuration using this embodiment.

The image capturing system shown in FIG. 1 is constructed with a CCD type solid-state image sensor 100, an image processing LSI 200 including an AFE (analog front end) section 210, an image processor 220 which performs digital image processing, and a CPU 230 which performs overall control of the chip, register configuration, etc., a system control LSI 300, and a circuit of auxiliary functions 400 such as optical zooming.

When, for example, the applied system is a mobile phone, the system control LSI 300 is an electronic device including a microcomputer or the like, specifically, including a baseband LSI responsible for processing of voice signals and transmit/receive signals and an LSI having functionality like a application processor involving multimedia processing functions such as motion picture processing complying with an MPEG scheme or the like, a resolution adjustment function, and a java high-speed processing function.

The AFE section 210 is composed of a Correlated Double Sampling (CDS) circuit 211 which samples pixel readout signals which are input from the image sensor, while eliminating noise, a variable gain amplifier (programmable gain amplifier) 212 which amplifies the sampled pixel readout signals up to a predetermined level, an A/D converter circuit 213 which converts the amplified analog pixel readout signals into digital signals, a timing generator circuit 214, etc.

The gain of the variable gain amplifier circuit 212 is controlled in an analog manner, based on a control signal (code) supplied from the CPU 230. The timing generator circuit 214 generates timing control signals to the CDS circuit 211 and the A/D converter circuit 213 as well as signals for timing control such as a CCD transfer pulse, readout pulse, and electronic shutter pulse which are supplied to the image sensor 100. Generated timing control pulses are sent to the image sensor via the driver IC 130 or the like.

The image processor 220 includes the functions such as a digital gain control amplifier 221 which amplifies digital pixel signals from the AFE, a color signal processor 222 and a luminance processor 223 which generate digital image data, and a luminance level sampling circuit 224 which samples the luminance values of the pixel signals and generates luminance level detection signals.

This image processor 220 is embodied in an arithmetic circuit like a digital signal processor (DSP) comprising multipliers and adders enabling product-sum operation as well as dividers, registers holding operation results, and a ROM or the like for storing a microprogram causing these arithmetic elements to operate in a predetermined sequence and output a desired operation result and coefficients. Thus, the above functions such as color signal processing are realized by arithmetic operations of the DSP.

The luminance level detection signals generated by the luminance level sampling circuit 224 are passed to the CPU 230 and used for auto exposure processing, auto white balancing, flicker detection, etc. The gain of the digital gain control amplifier 221 is controlled in a digital manner by a control signal supplied from the CPU 230.

Following the image processor 220, a digital interface (I/F) 251 is provided to output digital image data (including JPEG compressed data) generated by the above color signal processor 222 and luminance processor 223 and synchronization signals to the outside of the chip. Following the image processor 220, an NTSC converter circuit 252 is further provided which comprises a D/A converter circuit which converts generated digital image signals to video signals (color and luminance signals) compliant with a television standard, the National Television System Committee (NTSC) standard, and outputs the video signals.

By the provision of the digital interface (I/F) 251 and the NTSC converter circuit 252, it is possible to monitor video images from the camera on TV directly without using an additional external LSI. Image data stored within the mobile appliance may once be transferred into the image processing LSI of the present embodiment and delivered to TV from the NTSC output. Thus, the system that enables monitoring images on TV without using an additional external part can be built.

The image processor 220 is provided with various functions, which are not shown here, such as JPEG encoding (compression) and decoding (decompression) of image signals, digital zooming, image defect correction, resolution conversion, color correction, chroma control, and contrast control. Moreover, an IIC command interface 231 is attached to the CPU 230 so that a control command causing the CPU 230 to perform internal configuration of the chip is externally supplied.

Based on a signal from the image processor 220, the CPU 230 also controls arithmetic processing for the circuit of auxiliary functions 400 such as white balancing, flicker detection and canceling, auto focusing control, optical zooming control, and blurring correction. The CPU 230 is responsible for overall control of the chip according to a program executed by it. Also, the CPU 230 sets registers 215 and 227 holding the gain settings of the variable gain amplifier circuit 212 and the digital gain control amplifier 221. Gain control using the variable gain amplifier circuit 212 and the digital gain control amplifier 221 is disclosed in the above-mentioned Patent Document 1 and this is not further explained herein, as it is outside the scope of the present invention.

In the present embodiment, the register 215 that holds the gain setting (binary code) of the variable gain amplifier circuit 212 is provided within the AFE circuit 210 and the resister 227 that holds the gain setting of the digital gain control amplifier 221 is provided within the image processor 220. Arrangement is made such that the CPU 230 can set these registers by sending desired settings in a parallel manner to these registers via an internal bus 232.

Condition settings for executing the functions of the image processor 220 such as digital zooming, image defect correction, resolution conversion, color correction, chroma control, and contrast control are also performed by the CPU 230. In the system of FIG. 1, although arrangement is made such that digital pixel signals from the A/D converter circuit 213 are directly passed to the image processor (DSP) 220, it may be arranged such that these signals are passed to the image processor (DSP) 220 via the bus 232.

As above, the image processing LSI of the first embodiment is configured such that the AFE, which was conventionally formed separately from the CCD sensor and the image processing semiconductor integrated circuit (DSP), is formed together with the DSP and the CPU in a single chip semiconductor integrated circuit. This makes it possible to reduce the number of parts constituting the image capturing system and reduce the size and cost of a mobile electronic appliance having camera functionality.

By this arrangement in which the AFE circuit is formed together with the DSP and the CPU in a single chip semiconductor integrated circuit, the bus signal line through which the pixel readout signals are sent from the AFE circuit to the DSP can be formed on the chip instead of the printed wiring board. Consequently, power consumption required to drive the bus can be reduced and errors due to noise introduction can be suppressed.

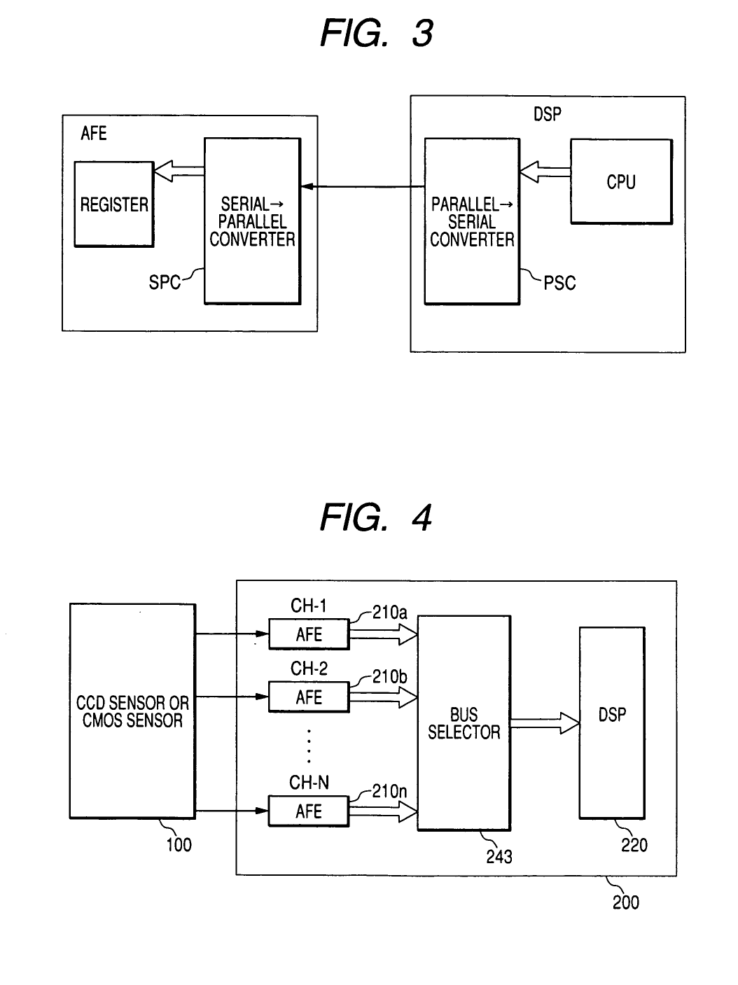

In the case where the AFE circuit is formed in a separate semiconductor chip different from the DSP chip, serial transfer of register setting data is required to allow the CPU to set the gain setting register for the variable gain amplifier circuit without increasing the number of wiring connections and the number of terminals between the chips. However, such serial transfer requires a parallel-serial converter PSC circuit at the DSP side and a parallel-serial converter SPC circuit at the AFE side, as shown in FIG. 3, which results in delay in booting of the system.

In contrast, the present embodiment is arranged such that the CPU 230 can set the registers 215, 227 by sending settings to the registers via the internal bus 232 in a parallel manner. Thereby, the time for sending the settings for the registers is reduced and there is no need for parallel-serial conversion and vice versa. Quicker booting of the system can be achieved.

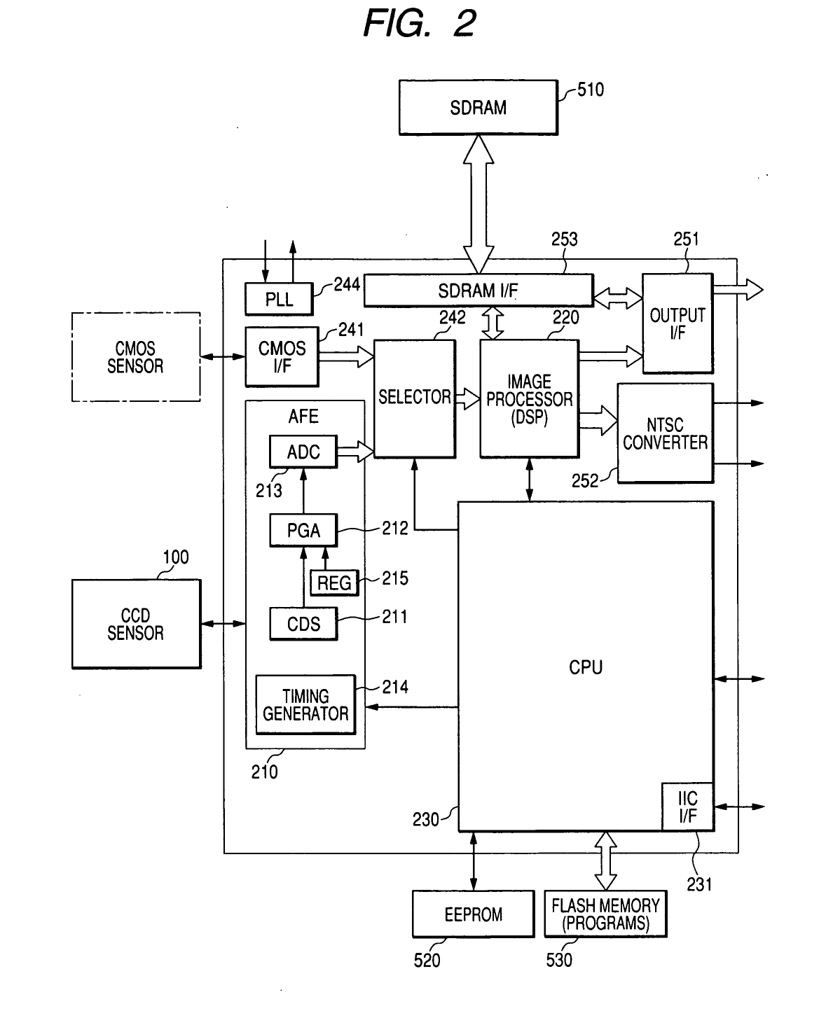

FIG. 2 shows a block diagram representing a second embodiment of an image processing LSI to which the present invention is applied and an example of an image capturing system configuration using this embodiment. Circuits having the same functions as the corresponding ones in the image processing LSI of the first embodiment in FIG. 1 are assigned the same numbers and their explanation is not repeated.

The image processing LSI of the second embodiment is provided with a CMOS interface 241 which receives signals output from a CMOS sensor including the AFE functionality and outputs a control signal to the AFE in the CMOS sensor. This LSI is configured so as to be able to process both image signals from the CCD sensor and image signals from the CMOS sensor.

Accordingly, a selector 242 is provided which selects either type of the image signals input from the CMOS sensor via the CMOS interface 241 and the image signals input from the CCD sensor via the AFE circuit 210 and supplies the selected signals to the DSP 220 as the image processor. A switching control signal that designates which type of image signals to be selected by the selector 242 is supplied from the CPU 230. In alternative arrangement, a register or flag associated with the selector 242 may be provided. In this arrangement, the CPU 230 may set the register or flag by sending a control code via the internal bus 232 thereto; thereby, the CPU 230 can control the selector 242 to select either type of image signals.

The image processing LSI of the second embodiment is also provided with a PLL circuit 244 which generates a clock as a multiple of an externally supplied clock and outputs it to the outside and inside of the chip. This facilitates synchronization with other chips constituting the image capturing system. Further, an SDRAM interface 253 is provided for connection to a volatile memory 510 like SDRAM which is used to store JPEG encoded image data produced by the image processor (DSP) 220.

Although not restrictive, a nonvolatile memory 520 like EEPROM for storing data specific to the system, such as gain settings for the variable gain amplifier circuits (212, 221) depending on the specifications of the used image sensors, is connected to the CPU 230. Another nonvolatile memory 530 like a flash memory for storing application programs or the like to be executed by the CPU is also connected to the CPU 230.

By the provision of the CMOS interface 241 and th selector 242 in the image processing LSI of the second embodiment, it is possible to provide a versatile image processing LSI that is able to process signals from each type of device, the CCD sensor without the AFE circuit or the CMOS sensor including the AFE circuit. When developing an image processing IC adapted for the CMOS sensor, based on an image processing IC for use connected to the CCD sensor, if the IC is configured so that processing is switchable between signals from the CMOS and signals from the CCD by using such selector circuit, it can be developed easily and the development cost and term can be reduced.

FIG. 4 shows an example of an essential configuration of a third embodiment of an image processing LSI according to the present invention.

In the third embodiment, the image processing LSI 200 includes N pieces of AFE circuits 210a, 210b, . . . 210n, adapted for the CCD sensor or CMOS sensor configured to be able to output a plurality of channels of image signal readout. Following these AFE circuits 210a, 210b, . . . 210n, a selector 243 is provided to select and supply signals from any AFE to the image processor 220.

The selector 243 sequentially sends digital pixel signals, results of conversion by the AFE circuits 210a, 210b, . . . 210n to the image processor 220 via the bus. Then, image signals of sub-areas are processed in a time division manner. By the way, it is rather easy to design a DSP (image processor) having an image data processing rate faster than the signal processing rate of an AFE that carries out analog signal processing. By applying the third embodiment, it is possible to provide an image processing LSI capable of image signal processing at a high speed, even in the case where an image sensor for a huge number of pixels is used.

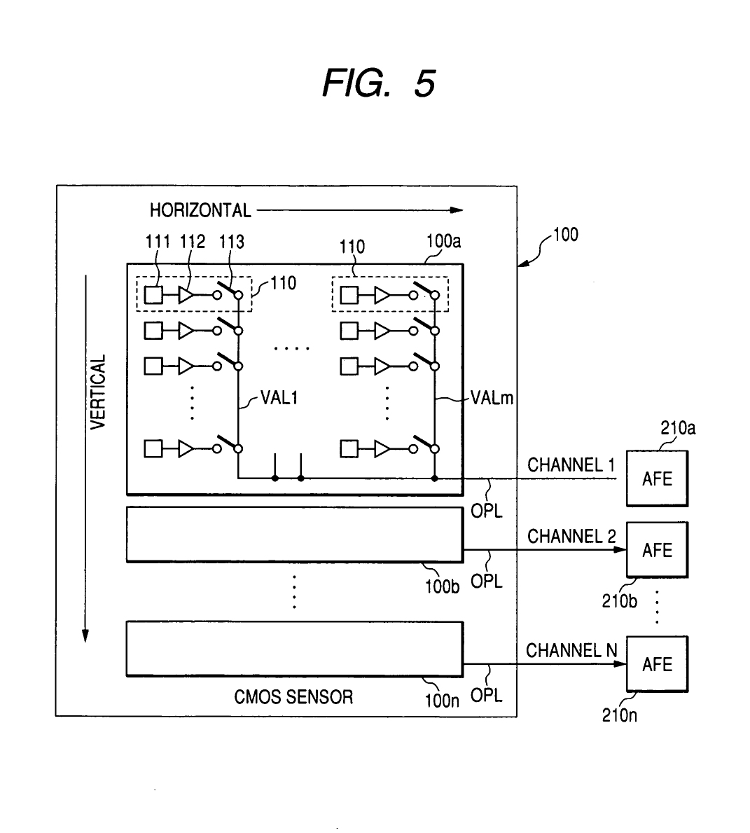

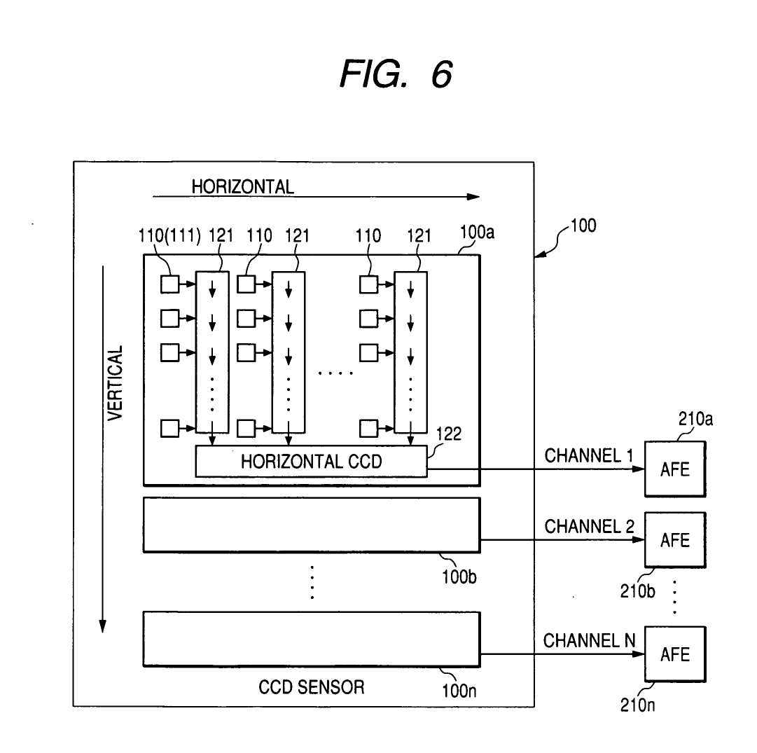

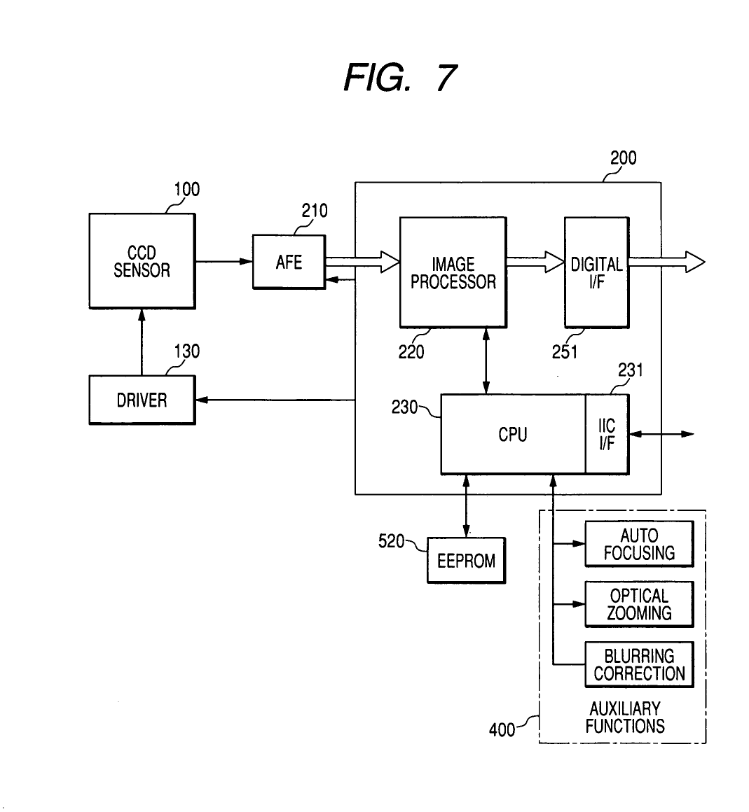

Here, a sensor that is able to output a plurality of channels of image signal readout is a sensor configured such that the image sensing area of the sensor 100 is divided into a plurality of sub-areas 100a, 100b, . . . 100n and parallel outputs of pixel signals read out from the sub-areas can be delivered, for example, as shown in FIG. 5 and FIG. 6. FIG. 5 depicts a CMOS sensor structure and FIG. 6 depicts a CCD sensor structure.

Each image sensing sub-area of the CMOS sensor, as shown in FIG. 5, is made up of a great number of unit cells, so-called pixels 110 arranged in a matrix of rows (horizontal) and columns (vertical). Each pixel 110 comprises a photo diode 111, an amplifier 112, anda select switch 113. The pixels are selected one by one in order and whose signals are read out by a horizontal transfer circuit (horizontal shift registers) and a vertical transfer circuit (vertical shift registers), which are not shown.

Specifically, first, the select switches 113 of the pixels on the first row are sequentially turned on and the voltages corresponding to the charges stored in the selected pixels are sequentially read out to vertical readout lines VALl to VALm and output to the corresponding AFE circuit 210 via a horizontal output line OPL. Then, the select switches 113 of the pixels on the second row are sequentially turned on and the voltages corresponding to the charges stored in the selected pixels are sequentially read out to the vertical readout lines VALl to VALm and output to the corresponding AFE circuit 210 via the output line OPL.

This operation is repeated sequentially and readout operations for the sub-areas 100a, 100b, . . . 100n take place in a parallel manner, i.e., simultaneously. Thereby, the voltages corresponding to the charges stored in all pixels of the image sensor are readout to the AFE circuits 210a, 210b, 210n. Upon the end of readout, the charges stored in the photo diodes 111 are discharged by a reset switch which is on/off controlled by a reset signal from a horizontal reset circuit and a vertical reset circuit, which are not shown.

Each image sensing sub-area of the CCD sensor, as shown in FIG. 6, is made up of pixels 110, each consisting of a photodiode (light receiving element) 111, are arranged in a matrix of rows (horizontal) and columns (vertical). Vertical transfer CCDs 121 are provided for each column of pixels and a horizontal transfer CCD 122 is provided.

Charges stored in the pixels 110 are once transferred to the vertical transfer CCDs 121 and transferred through the vertical transfer CCDs 121 to the horizontal transfer CCD 122. The charges are sequentially read out to the corresponding AFE circuit 210 through the horizontal transfer CCD 122. This operation takes place for the sub-areas 100a, 100b, . . . 100n in a parallel manner. Thereby, the charges stored in all pixels of the image sensorare readout to the AFE circuits 210a, 210b, . . . 210n.

While the invention made by the present inventors has been described specifically based on its illustrative embodiments hereinbefore, it will be appreciated that the present invention is not limited to the described embodiments and various modifications may be made without departing from the gist of the invention. For example, although the foregoing embodiments illustrated the examples of the image processing LSI including the NTSC converter circuit 252, the NTSC converter is necessary for the LSI as a component of a video camera, but may be omitted, as its provision is not always needed, if the image processing LSI is used as a component of a camera or the like incorporated in a mobile phone. The digital gain control amplifier 221 provided in the image processor 220 is not always needed.

While the foregoing embodiments illustrated the examples in which the AFE or AFEs are integrated into the image processing LSI having the DSP and CPU, the second embodiment (FIG. 2) and the third embodiment (FIG. 4) may be applied to a case where the AFE or AFEs are integrated into a chip on which the DSP is installed, when the DSP and the CPU are constructed on separate chips. Any combination of the embodiments shown in FIG. 1, FIG. 2, and FIG. 4 may be applied.

In the foregoing description, the invention made by the present inventors has mainly been explained in relation to its application to the image processing IC suitable for use as a component of a camera incorporated in a mobile electronic appliance such as mobile phones, which are regarded as the background usage field of the invention. The present invention is not so limited and may be applied to, for example, a video camera, monitoring camera, web camera, digital still camera for capturing still images, etc.

1. An image data processing semiconductor integrated circuit comprising:
an analog front end circuit which samples pixel readout signals input from a solid-state image sensor, amplifies the sampled signals up to a predetermined level, and converts the amplified signals into digital signals;
a digital image processing circuit for digital image processing on digital signals from said analog front end circuit; and
a microcomputer responsible for arithmetic processing and control for camera functionality,
wherein the analog front end circuit, the digital image processing circuit, and the microcomputer are formed over a single semiconductor chip.

2. The image data processing semiconductor integrated circuit according to claim 1,
wherein said analog front end circuit comprises:
a sampling circuit which samples the pixel readout signals input from said solid-state image sensor;
an analog variable gain amplifier circuit which amplifies the sampled pixel readout signals up to a predetermined level;
an A/D converter circuit which converts the amplified analog pixel readout signals into digital signals; and
a register which holds a setting within said analog front end circuit,
wherein said register is arranged such that a value supplied in a parallel manner from said microcomputer is set in the register.

3. The image data processing semiconductor integrated circuit according to claim 2, wherein said register is arranged such that a value provided by said microcomputer via an internal bus is set in the register.

4. The image data processing semiconductor integrated circuit according to claim 2, wherein said register is the register to hold a code that designates gain of said analog variable gain amplifier circuit.

5. The image data processing semiconductor integrated circuit according to claim 2, wherein said digital image processing circuit comprises a digital signal processor.

6. The image data processing semiconductor integrated circuit according to claim 1, further comprising:
a signal path for guiding the pixel readout signals input from the solid-state image sensor to said digital image processing circuit, bypassing said analog front end circuit; and
a selecting means for selecting either signals from said signal path or signals from said analog front end circuit and supplying the selected signals to said digital image processing circuit.

7. The image data processing semiconductor integrated circuit according to claim 6, wherein said selecting means is arranged such that selection is made, based on a control signal or a control code from said microcomputer.

8. The image data processing semiconductor integrated circuit according to claim 6, wherein the pixel readout signals which are input to said analog front end circuit are pixel readout signals from a CCD type solid-state image sensor and the pixel readout signals which are supplied to said signal path are pixel readout signals from a CMOS type solid-state image sensor including the analog front end circuit.

9. The image data processing semiconductor integrated circuit according to claim 1, including a plurality of analog front end circuits which sample pixel readout signals input through a plurality of parallel channels from the solid-state image sensor, amplify the sampled signals up to a predetermined level, and convert the amplified signals into digital signals.

10. The image data processing semiconductor integrated circuit according to claim 9, further including a second selecting means for selecting digital signals converted in any one of said plurality of analog front end circuits and supplying the selected signals to said digital image processing circuit.
